(19) United States
(12) Patent Application Publication
(10) Pub. No.: US 2024/0003486 A1
(43) Pub. Date: Jan. 4, 2024

(54) SEMI-AUTOMATIC OVERHANGING PLASTIC PART FOR FIXING AND RELEASING AN OVERHANGING ROD

(71) Applicant: Sophia & William Brands Co., LTD, Nanjing (CN)

(72) Inventor: Meidi Chen, Nanjing (CN)

(21) Appl. No.: 17/854,587

(22) Filed: Jun. 30, 2022

(51) Int. Cl. F16M 13/02; E04H 15/48

(52) U.S. Cl. CPC F16M 13/02; E04H 15/48

(57) ABSTRACT

The disclosure discloses a semi-automatic overhanging plastic part for fixing and releasing an overhanging rod, comprising the overhanging rod and the plastic part, the overhanging rod is a hollow oval flat tube, and the inside of the overhanging rod is provided with an elastic clamping convex, and the elastic clamping convex and the overhanging rod are matched and connected, a U-shaped groove is arranged on the plastic part, a positioning button is arranged on one side of the U-shaped groove, and the positioning button is fixed on the plastic part by a fixing rod. Compared with the prior art, the invention has the advantages that the overhanging rod can be fixed on the tent frame in advance, the positioning button on the plastic part cooperates with the overhanging rod, and at the same time plays the role of fixing and releasing the overhanging rod, it is easy to us.

### 1. TECHNICAL FIELD

The invention relates to the technical field of tents, in particular to a semi-automatic overhanging plastic part for fixing and releasing an overhanging rod.

### 2. BACKGROUND ART

In outdoor sports, tents are often used for shade or shelter from the rain. A common method for installing and disassembling the tent overhanging rod in the prior art is to use the overhanging rod as a separate accessory, which can be fixed and disassembled by simply pulling and inserting or using screws, this action needs to be repeated every time it is built, which is not user-friendly, and the structure is not beautiful in appearance, and the structure is not stable enough.

### 3. SUMMARY OF THE INVENTION

The technical problem to be solved by the invention is to provide a semi-automatic overhanging plastic part for fixing and releasing an overhanging rod in view of the above problems.

In order to solve above technical problem, the invention provides the following technical scheme: a semi-automatic overhanging plastic part for fixing and releasing an overhanging rod, comprising the overhanging rod and the plastic part, the overhanging rod is a hollow oval flat tube, and the inside of the overhanging rod is provided with an elastic clamping convex, and the elastic clamping convex and the overhanging rod are matched and connected, a U-shaped groove is arranged on the plastic part, a positioning button is arranged on one side of the U-shaped groove, and the positioning button is fixed on the plastic part by a fixing rod.

As an improvement, the overhanging rod is matched and connected with the U-shaped groove of the plastic part, the U-shaped groove is formed by hollowing out the angle from the upper right to the lower left, when the overhanging rod is rotated 180° counterclockwise, it can just enter the U-shaped groove, and the U-shaped groove can perfectly fit the shape of the overhanging rod.

As an improvement, the positioning button is a double-cylinder connection structure with a large diameter at one end and a small diameter at the other end, a track is arranged on the large cylinder, and the track and the fixing rod are matched and connected, when the positioning button is fixed, it can be bounced back and forth, and the amplitude of the bounce is consistent with the width of the track.

Compared with the prior art, the invention has the advantages that the overhanging rod can be fixed on the tent frame in advance, the positioning button on the plastic part cooperates with the overhanging rod, and at the same time plays the role of fixing and releasing the overhanging rod, it is easy to use, more convenient to install, more stable in structure, and more novel and beautiful in appearance compared with the traditional structure.

### 4. BRIEF DESCRIPTION OF ACCOMPANY DRAWINGS

FIG. 1 is the structure diagram of the semi-automatic overhanging plastic part for fixing and releasing an overhanging rod.

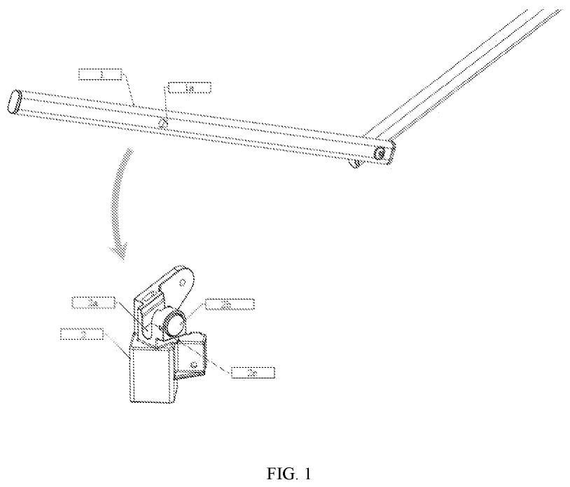

FIG. 2 is the combined state diagram of the semi-automatic overhanging plastic part for fixing and releasing an overhanging rod.

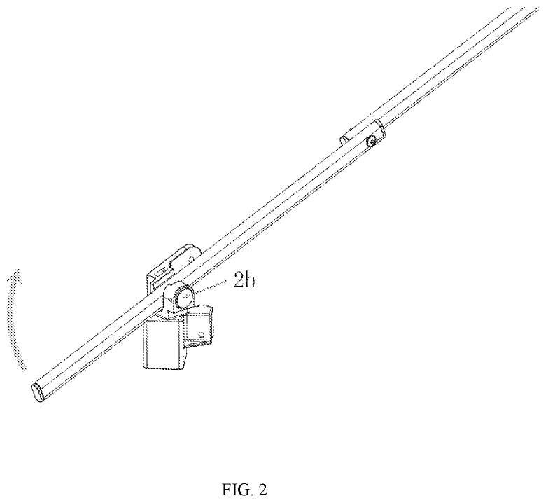

FIG. 3 is the structure diagram of the positioning button of the semi-automatic overhanging plastic part for fixing and releasing an overhanging rod.

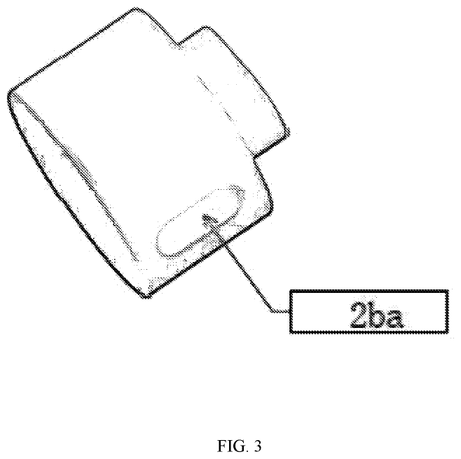

As shown in the accompanying drawings: 1 overhanging rod, 1a elastic clamping convex, 2 plastic part, 2a U-shaped groove, 2b positioning button, 2ba track, 2c fixing rod.

### 5. SPECIFIC EMBODIMENT OF THE INVENTION

The invention is further explained in detail in combination with the accompany drawings.

In the specific embodiments of the invention, a semi-automatic overhanging plastic part for fixing and releasing an overhanging rod, comprising the overhanging rod 1 and the plastic part 2, the overhanging rod 1 is a hollow oval flat tube, and the inside of the overhanging rod 1 is provided with an elastic clamping convex 1a, and the elastic clamping convex 1a and the overhanging rod 1 are matched and connected, a U-shaped groove 2a is arranged on the plastic part 2, a positioning button 2b is arranged on one side of the U-shaped groove 2a, and the positioning button 2b is fixed on the plastic part 2 by a fixing rod 2c.

As an improvement, the overhanging rod 1 is matched and connected with the U-shaped groove 2a of the plastic part 2, the U-shaped groove 2a is formed by hollowing out the angle from the upper right to the lower left, when the overhanging rod 1 is rotated 180° counterclockwise, it can just enter the U-shaped groove 2a, and the U-shaped groove 2a can perfectly fit the shape of the overhanging rod 1.

As an improvement, the positioning button 2b is a double-cylinder connection structure with a large diameter at one end and a small diameter at the other end, a track 2ba is arranged on the large cylinder, and the track 2ba and the fixing rod 2c are matched and connected, when the positioning button 2b is fixed, it can be bounced back and forth, and the amplitude of the bounce is consistent with the width of the track.

The working principle of the invention: a semi-automatic overhanging plastic part for fixing and releasing an overhanging rod, comprising the plastic part sleeved on the top of the tent leg pipe, a U-shaped groove and a positioning button are correspondingly arranged on the plastic part. The user manually rotates the overhanging rod 180° counterclockwise to the U-shaped groove, the overhanging rod is a hollow oval flat tube, the hollow oval flat tube is equipped with an elastic clamping convex, the protrusion of the elastic clamping convex protrudes from the outer surface of the overhanging rod, and is matched with the positioning button on the plastic part to fix the overhanging rod; when unlocking, the user presses down the positioning button to fit with the elastic clamping convex on the overhanging rod, and the elastic clamping convex is retracted into the overhanging rod, and at the same time, the overhanging rod is manually rotated clockwise to the initial position.

In addition, the terms of “first” and “second” are only used for descriptive purposes, and should not be construed as indicating or implying relative importance or implying the number of indicated technical features. Therefore, the features defined with “first” and “second” may expressly or implicitly include one or more of the features, and in the description of the invention, the meaning of “multiple” is two or two above, unless otherwise expressly specifically defined.

In the invention, the terms of “arrange”, “link”, “connect” and “fix” etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

In the invention, the first feature “above” or “below” the second feature may include the first feature and second feature in direct contact, or may include the first feature and second feature not in direct contact but in contact through additional feature between them unless there are specific restrictions or stipulations. Moreover, the first feature being “on”, “above” and “over” the second feature includes the first feature being directly above and obliquely above the second feature, or simply means that the first feature has a higher level than the second feature. The first feature is “under”, “below” and “underneath” the second feature includes the first feature is directly below and diagonally below the second feature, or simply means that the first feature has a lower level than the second feature.

In the description of the specification, the reference terms “one embodiment”, “some embodiments”, “example”, “specific example”, “some examples” and etc., may refer to that the specific features, structures, materials or characteristics described by combining the embodiment or example are included in at least one embodiment or example. In the specification, schematic statement of above terms does not necessarily refer to the same embodiment or example. In addition, the described specific features, structures, materials, or characteristics may be combined in any one or more embodiments or examples in an appropriate manner.

Although the embodiments of the invention have been shown and described above, it should be understood that the above embodiments are exemplary and should not be construed as limiting the invention. Those skilled in the art can make changes, modifications, substitutions and alterations to the above-described embodiments within the scope of the invention without departing from the principles and spirit of the invention.

1. A semi-automatic overhanging plastic part for fixing and releasing an overhanging rod, comprising the overhanging rod (1) and the plastic part (2), the overhanging rod (1) is a hollow oval flat tube, and the inside of the overhanging rod (1) is provided with an elastic clamping convex (1a), and the elastic clamping convex (1a) and the overhanging rod (1) are matched and connected, a U-shaped groove (2a) is arranged on the plastic part (2), a positioning button (2b) is arranged on one side of the U-shaped groove (2a), and the positioning button (2b) is fixed on the plastic part (2) by a fixing rod (2c).

2. A semi-automatic overhanging plastic part for fixing and releasing an overhanging rod of claim 1, the overhanging rod (1) is matched and connected with the U-shaped groove (2a) of the plastic part (2).

3. A semi-automatic overhanging plastic part for fixing and releasing an overhanging rod of claim 1, the positioning button (2b) is a double-cylinder connection structure with a large diameter at one end and a small diameter at the other end, a track (2ba) is arranged on the large cylinder, and the track (2ba) and the fixing rod (2c) are matched and connected.
